(19) United States
(12) Patent Application Publication
(10) Pub. No.: US 2026/0054534 A1
(43) Pub. Date: Feb. 26, 2026

(54) Coupler Assembly

(71) Applicant: Curt Manufacturing, LLC, Eau Claire, WI (US)

(72) Inventor: Curtis M. Bowe, Chippewa Falls, WI (US)

(21) Appl. No.: 19/303,149

(22) Filed: Aug. 18, 2025

Related U.S. Application Data
(60) Provisional application No. 63/685,071, filed on Aug. 20, 2024.

(51) Int. Cl. B60D 1/28; B60D 1/06

(52) U.S. Cl. CPC B60D 1/28; B60D 1/06

(57) ABSTRACT

A coupler assembly includes a coupler socket housing which receives the gooseneck or other tow ball. The coupler socket housing has a locking pin channel with a locking pin therein able to move between a) a locking position extending under the socket hemisphere; and b) a release position wider than the socket hemisphere so as to allow the coupler assembly to be downwardly placed onto the tow ball or upwardly removed from the tow ball. A handle is attached, accessible outside the coupler socket housing. The handle can be used to move the locking pin along the centerline of the locking pin, and can also be used to turn the locking pin about the locking pin centerline. A gooseneck tube mount is pivotally secured to the coupler socket housing over an elastomeric insert for vertical damping of the coupler assembly.

### CROSS-REFERENCE TO RELATED APPLICATION(S)

The present application claims priority from U.S. Provisional Application No. 63/685,071 entitled GOOSENECK COUPLER ASSEMBLY and filed Aug. 20, 2024, incorporated herein by reference.

### BACKGROUND OF THE INVENTION

The present invention relates to towing using a hitch ball or tow ball. Such hitch or tow balls have a generally spherical outer profile extending above a neck, although the ball may have one or more flats and/or indentations such as being stamped with printed information regarding towing strength. The hitch or tow ball is mounted on a towing vehicle with the relationship between the generally spherical outer profile and the neck defining a generally vertical tow ball axis. Most trailer couplers for such tow balls include a locking pin or locking latch which extends laterally behind the ball beneath an equator of the ball to hold the coupler to the ball while still allowing the coupler and towed trailer to pivot about the centerpoint of the ball.

More particularly, the present invention relates to a gooseneck coupler assembly mounted on the gooseneck of a towed trailer to be used to couple the gooseneck trailer to a hitch or tow ball centrally mounted in the bed of a pickup truck. Examples of a gooseneck hitch ball with which the present invention can be used are shown in U.S. Pat. Pub. Nos. 2023/0347696 and 2024/0157739, both incorporated by reference. An existing gooseneck coupler is shown in U.S. Pat. Pub. No. 2023/0127867, incorporated by reference.

Recently, improvements have been devised which allow relative movement between a hitch ball and its base/shank, as disclosed in U.S. Pat. Nos. 11,192,408 and 11,685,206, both incorporated by reference. The hitches of U.S. Pat. Nos. 11,192,408 and 11,685,206 include a compressible insert placed within the structure to compressibly resist the relative movement.

### BRIEF SUMMARY OF THE INVENTION

The present invention is a coupler assembly for use with a gooseneck tow ball or other tow ball. In one aspect, the coupler assembly includes a coupler socket housing which receives the ball in a socket hemisphere, and which has a locking pin channel with a locking pin received therein. The locking pin is able to move between a) a locking position wherein a distal end of the locking pin is under the socket hemisphere so as to prevent removal of the coupler assembly from the tow ball; and b) a release position wherein the distal end is positioned wider than the socket hemisphere so as to allow the coupler assembly to be downwardly placed onto the tow ball or upwardly removed from the tow ball. A handle is attached, accessible outside the coupler socket housing. The handle can be used to move the locking pin along the centerline of the locking pin, and can also be used to turn the locking pin about the locking pin centerline. The combination of the axial motion and the turning motion enable the coupler assembly to auto-latch when reattaching to a ball.

In another aspect, the coupler assembly includes a gooseneck tube mount pivotally secured to the coupler socket housing. An elastomeric insert is positioned so as to be compressed by pivoting of the gooseneck tube mount relative to the coupler socket housing. The elastomeric insert provides damping of the coupler assembly, which in the preferred embodiment is primarily associated with vertical motion of the gooseneck tongue.

### BRIEF DESCRIPTION OF THE DRAWINGS

FIG. 1 is a perspective view, from the upper-rear-left, of a first preferred embodiment of a gooseneck coupler assembly in accordance with the present invention.

FIG. 2 is a perspective view, from the upper-front-left, of the gooseneck coupler assembly of FIG. 1 shown attached relative to a portion of a gooseneck tube.

FIG. 3 is an exploded perspective view of the gooseneck coupler assembly of FIGS. 1 and 2.

FIG. 4 is a top plan view of the coupler socket housing of the gooseneck coupler assembly of FIGS. 1-3.

FIG. 5 is a side elevational view of the coupler socket housing of FIG. 4.

FIG. 6 is a cross-sectional side view of the coupler socket housing of FIGS. 4 and 5, taken along cut-line 6-6 of FIG. 4.

FIG. 7 is a top plan view of the gooseneck tube mount of the gooseneck coupler assembly of FIGS. 1-3.

FIG. 8 is a side elevational view of the gooseneck tube mount of FIG. 7.

FIG. 9 is a front view of the gooseneck tube mount of FIGS. 7 and 8.

FIG. 10 is a cross-sectional side view of the gooseneck tube mount of FIGS. 7-9, taken along cut-line 10-10 of FIG. 9.

FIG. 11 is a cross-sectional view of the gooseneck tube mount of FIGS. 7-10, taken along cut-line 11-11 of FIG. 10.

FIG. 12 is a perspective view of the locking pin used in the gooseneck coupler assembly of FIGS. 1-3.

FIG. 13 is a side view of the locking pin of FIG. 12.

FIG. 14 is a top view of the locking pin of FIGS. 12 and 13.

FIG. 15 is a cross-sectional side view, showing the coupler socket housing and locking pin of the gooseneck coupler assembly of FIGS. 1-3 attached to a hitch ball.

FIG. 16 is a cross-sectional view of a portion of FIG. 15, taken along cut line 16-16 of FIG. 15.

FIG. 17 is a cross-sectional side view, showing the coupler socket housing and locking pin of the gooseneck coupler assembly of FIGS. 1-3 after the locking pin has been pulled to a release position.

FIG. 18 is a cross-sectional view of a portion of FIG. 17, taken along cut line 18-18 of FIG. 17.

FIG. 19 is a cross-sectional side view, showing the coupler socket housing and locking pin of the gooseneck coupler assembly of FIGS. 1-3 after the locking pin has been further rotated to an orientation where the locking pin is held upward by the locking pin housing (locking pin housing not shown in FIG. 19, but shown in FIGS. 1 and 3).

FIG. 20 is a cross-sectional view of a portion of FIG. 19, taken along cut line 20-20 of FIG. 19.

FIG. 21 is a cross-sectional side view, showing the coupler socket housing and locking pin of the gooseneck coupler assembly of FIGS. 1-3, while jacking of the trailer higher causes hitch ball to turn the locking pin back −35°to a 0°orientation.

FIG. 22 is a cross-sectional view of a portion of FIG. 21, taken along cut line 22-22 of FIG. 21.

FIG. 23 is a perspective view, from the upper-rear-left, of a second preferred embodiment of a gooseneck coupler assembly in accordance with some aspects of the present invention.

FIG. 24 is a perspective view, from the upper-rear-left, of a third preferred embodiment of a trailer coupler assembly in accordance with some aspects of the present invention.

FIG. 25 is a perspective view, from the upper-rear-left, of a fourth preferred embodiment of a trailer coupler assembly in accordance with some aspects of the present invention.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

The present invention stems from identifying issues with the current state-of-the-art in gooseneck couplers. In particular, most gooseneck couplers require manipulation by the operator to complete engagement or latching onto the gooseneck hitch ball. Further, gooseneck couplers can be noisy as the trailer hits bumps in the road during towing. More efficient structures and coupling methods are possible.

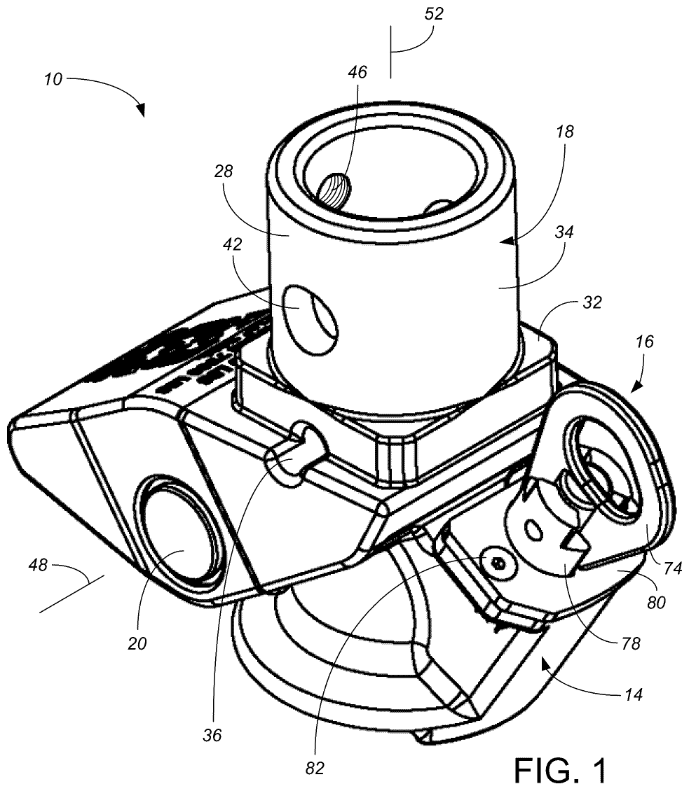

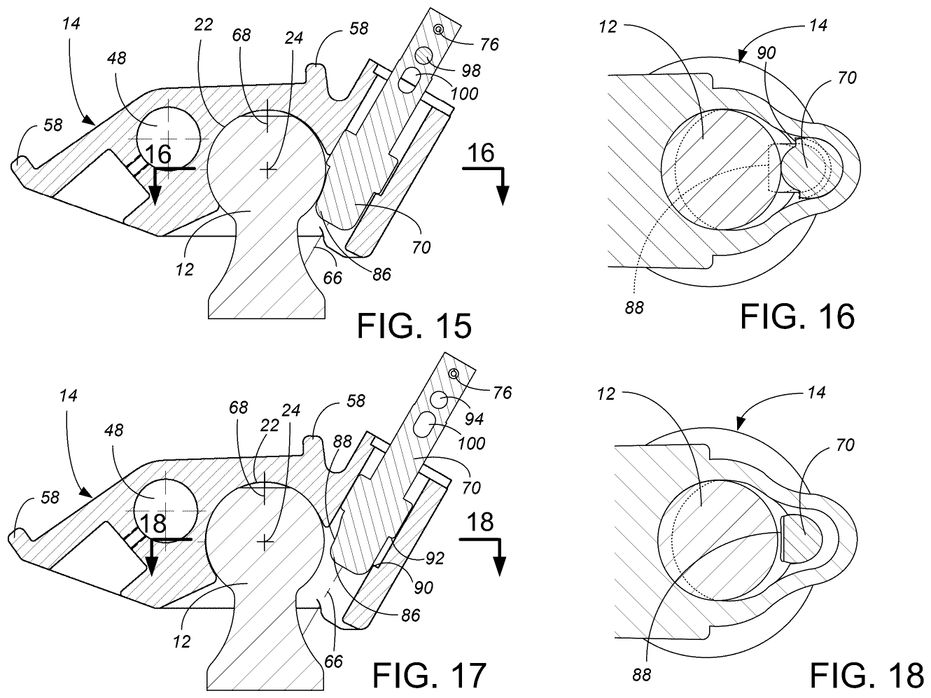

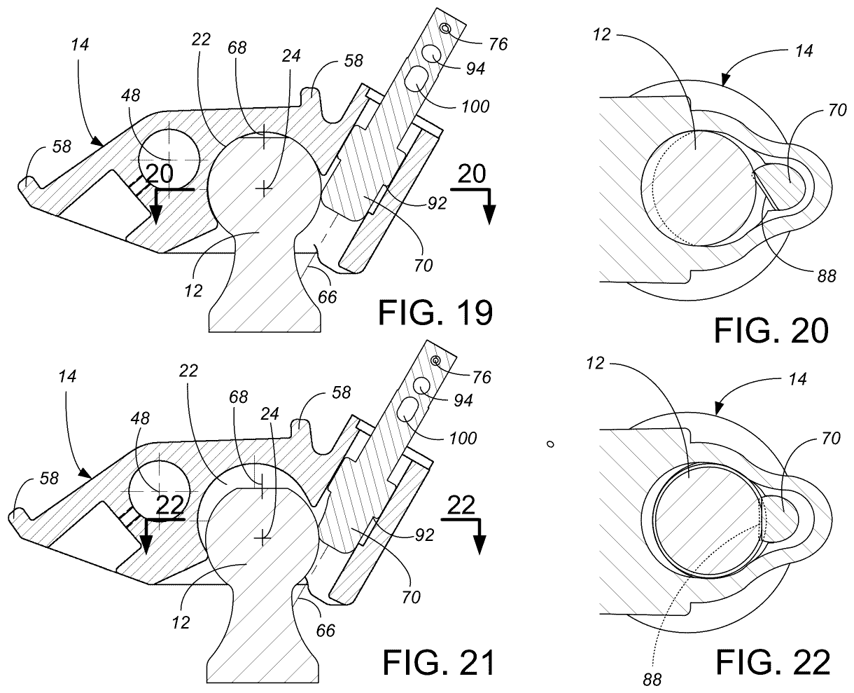

The preferred coupler assembly 10 as shown in FIGS. 1-3 is used for coupling a gooseneck trailer (not shown) to a hitch or tow ball 12 shown in FIGS. 15-22. The preferred coupler assembly 10 includes a coupler socket housing 14 with a lock 16 on the bottom and a gooseneck tube mount 18 on the top which is pivotally attached to the coupler socket housing 14 by a pivot pin 20. The coupler socket housing 14 defines a socket hemisphere 22 (best called out in FIG. 6) for receiving the tow ball 12 when the coupler assembly 10 is placed onto the tow ball 12 from above. In the preferred embodiment shown, the socket hemisphere 22 has a 59.5 mm inner diameter, to mate with and receive a 2 5/16″ (58.7 mm) ball 12 most commonly used for gooseneck towing. Depending upon the application, the socket hemisphere 22 could have a different inner diameter, such as for receiving a 1 ⅞″ or 2″ ball. The coupler socket housing 14 does not need to make contact with the entire surface of the ball 12, but should make sufficient sliding contact with the ball 12 so as to allow limited articulation in all directions about the centerpoint 24 of the sphere defined by the ball 12. The bottom edge of the socket hemisphere 22 need not be horizontal relative to a bottom plane 26 of the coupler socket housing 14 and intended usage orientation, and in the preferred embodiment is canted forwardly at hemisphere cant angle α (called out in FIG. 6) of about 26° to horizontal.

The gooseneck tube mount 18 includes an upper mounting section 28 adapted for mounting inside a vertically extending tube 30 of a gooseneck trailer (not shown). In the preferred embodiment, this upper mounting section 28 includes a lower square section 32 and an upper cylindrical section 34. The lower square section 32 is sized to tightly fit inside typical square tubes 30 of existing gooseneck trailers, such as being about ¾″ (19 mm) high and about a 3 ⅓″ (85 mm) sided square with generously rounded corners. The upper cylindrical section 34 is sized to fit into either typical square tubes 30 or typical cylindrical tubes (not shown) of existing gooseneck trailers, such as being about another 3″ (76 mm) high and about 3 ⅓″ (85 mm) in diameter. The upper mounting section 28 could be solid but is more preferably hollow so as to reduce weight, but still having sufficient wall thickness to support the towing forces typically found in gooseneck towing, such as a wall thickness of about ½″ (13 mm). With a hollow upper mounting section 28, there is a possibility of precipitation retention within the upper mounting section 28. The preferred gooseneck tube mount 18 has a water drip channel 36 allowing drainage from an interior of the gooseneck tube mount 18 to an exterior of the gooseneck tube mount 18. Alternative embodiments use only one of the square section 32 and the cylindrical section 34, so as to be mountable only to one shape of existing gooseneck trailer tubes.

The upper cylindrical section 34 is preferably positively but removably attached to the gooseneck trailer tube 30 using two bolts 38, 40. A through-bolt 38 extends through sets of collinear holes 42 in the opposing walls of both the gooseneck trailer tube 30 and the cylindrical section 34, held in place by a locknut 44. Tightening of the locknut 44 ensures a tight connection in the transverse or lateral direction. A set bolt 40 extends through a hole (not separately called out) in the gooseneck trailer tube 30 and is threaded into a threaded hole 46 in the cylindrical section 34. Tightening of the set bolt 40 ensures a tight connection in the longitudinal direction. Alternative embodiments integrally and/or permanently fix the gooseneck tube mount 18 to the gooseneck tube 30 such as by welding. As another example, the upper mounting section 28 could be welded to a pin box of a gooseneck pin box adapter, enabling a fifth wheel trailer to be towed using the coupler assembly 10 of the present invention instead of the traditional fifth wheel's kingpin and hitch jaws.

Both the coupler socket housing 14 and the gooseneck tube mount 18 are preferably formed of a strong, rigid material with strength and toughness acceptable for towing forces, such as steel, most preferably 5140 medium-carbon, low-alloy steel cast into the shape shown and heat treated to 24-28 Rockwell C. The pivot pin 20 is also formed of a strong, rigid material with strength and toughness acceptable for towing forces, such as steel, most preferably 42 Chromium-Molybdenum medium-carbon alloy steel machined into the shape shown and heat treated to 32-36 Rockwell C. The pivot pin connection allows the gooseneck tube mount 18 to pivot relative to the coupler socket housing 14 about the horizontal axis 48 of the pivot pin 20.

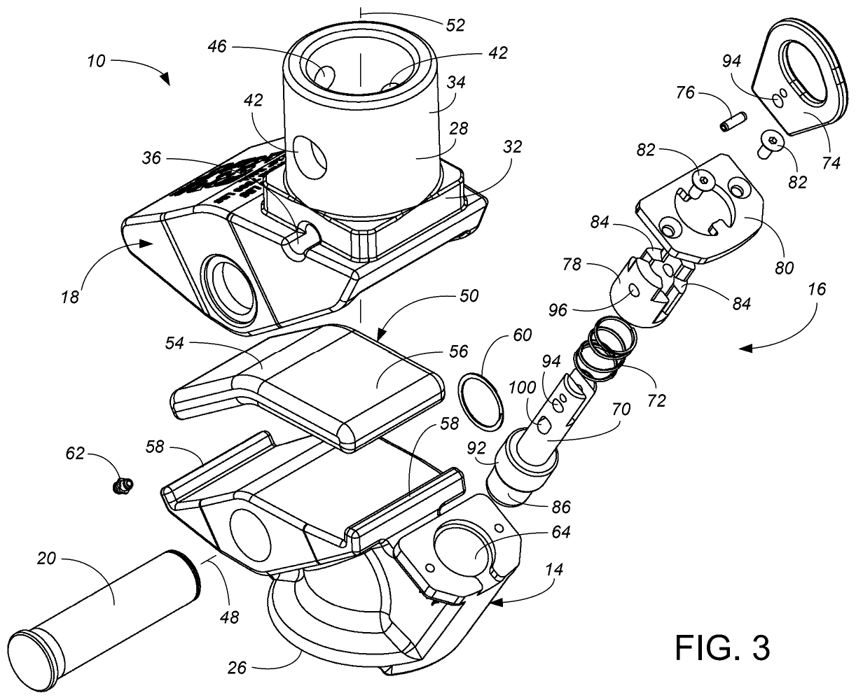

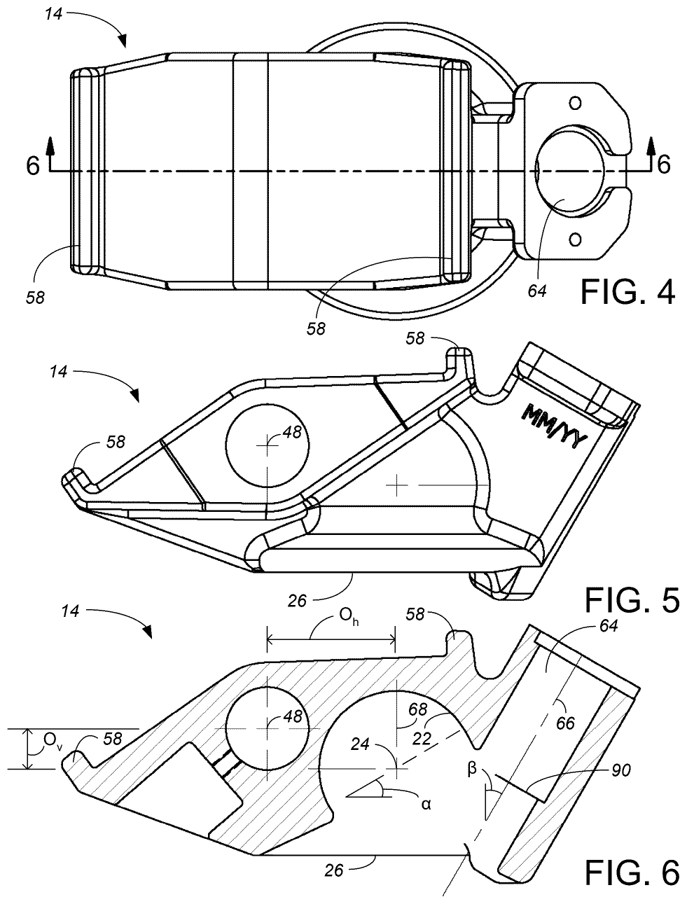

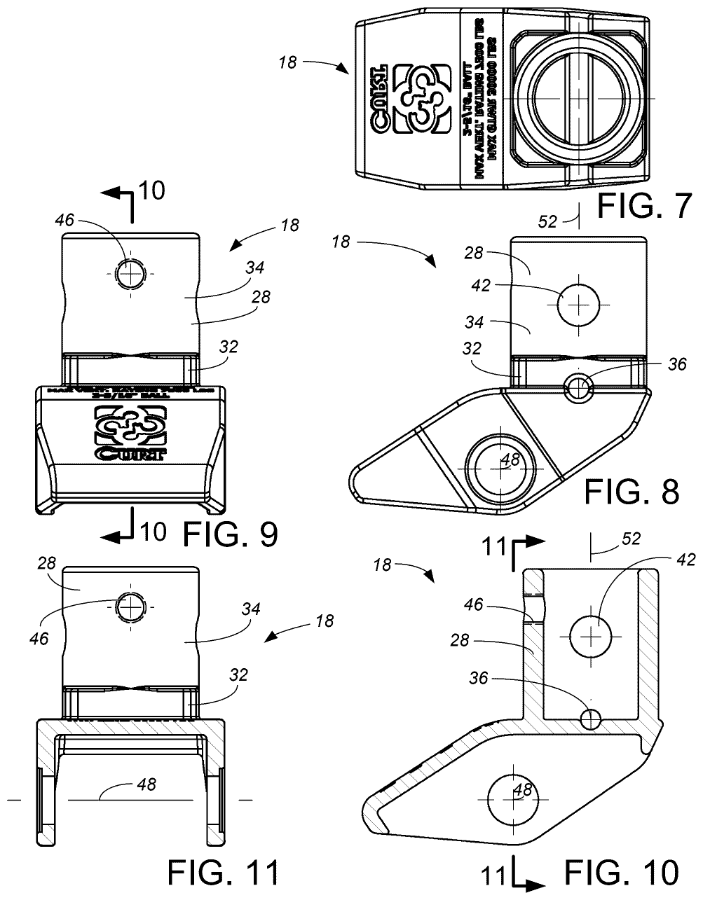

As best shown in FIG. 3, a compressible elastomeric insert 50 is sandwiched in between the coupler socket housing 14 and the gooseneck tube mount 18. The insert 50 provides shock damping between the coupler socket housing 14 and the gooseneck tube mount 18, most significantly in the vertical direction. In particular, the ball 12 in gooseneck towing is preferably positioned in the middle of the towing vehicle truckbed (not shown), centered above the rear wheel axis (not shown). The ball 12 is typically rigidly mounted to the bed, moving substantially identically with the rear suspension travel of the towing vehicle. The gooseneck tube 30 extends a significant offset distance upward (typically two feet (61 cm) or more), substantially vertically above the ball 12, an offset that does not significantly exist in most trailer ball hitch attachments (where the trailer tongue extends substantially horizontally at the approximate elevation of the ball 12). Because of the significant vertical offset of the gooseneck tube 30, the ball-in-socket joint of the ball 12 in the coupler socket housing 14 by itself allows some articulated movement of the trailer forwardly and rearwardly relative to the towing vehicle by compression of the trailer shocks. Despite this different layout of towing forces, gooseneck hitches can still be noisy, primarily due to differing vertical loads on the gooseneck tongue.

In the preferred layout of the coupler assembly 10, the pivot axis 48 is offset further horizontally than vertically from the ball centerpoint 24, preferably in front of and slightly higher than the ball centerpoint 24, such as by a horizontal offset Oₕ of about 2″ (50 mm) and a vertical offset Oᵥ of about ⅗″ (15 mm) both called out in FIG. 6. The preferred layout of the coupler assembly 10 generally aligns (i.e., within about 1 inch (25 mm), and more preferably within ¼ inch (6 mm) or less) the gooseneck tube axis 52 with the tow ball centerpoint 24 while the coupler assembly 10 is unbiased (i.e., bearing no tongue weight). That is, the pivotally securing of the gooseneck tube mount 18 to the coupler socket housing 14 includes a position where the gooseneck tube axis 52 intersects the tow ball centerpoint 24. The three-piece assembly allows damping movement of the gooseneck of the trailer relative to the hitch ball 12 somewhat in accordance with the teachings of U.S. Pat. Nos. 11,192,408 and 11,685,206, incorporated by reference, but with a different layout than shown in U.S. Pat. Nos. 11,192,408 and 11,685,206. It is noteworthy that the damping movement occurs downstream (i.e., on the trailer side) of the ball 12 rather than upstream of the ball 12 (i.e., NOT on the towing vehicle side of the ball 12), allowing the ball 12 to be rigidly mounted in the middle of the towing vehicle bed. The fact that the horizontal offset Oₕ is greater than the vertical offset Oᵥ means that the damping movement occurs to dampen vertical forces more than horizontal forces on the gooseneck tube 30.

The most preferred elastomeric insert 50 is formed of polyurethane cast at about ⅔″ (17 mm) thick, having a durometer of 95-100 Shore A. The elastomeric insert 50 includes a bend 54 extending over the pivot pin 20, such that a larger trailing section 56 absorbs the standing vertical tongue weight of the gooseneck tube 30. The elastomeric insert 50 is preferably positioned in a pocket defined by the coupler socket housing 14 and the gooseneck tube mount 18, which both protects the elastomeric insert 50 from sun exposure and prevents excessive squeezing forces and compressive failure of the elastomeric material of the insert 50. Additionally, the coupler socket housing 14 is preferably provided with hard stops 58 that can contact the gooseneck tube mount 18 to limit pivoting to 5° in either (clockwise or counterclockwise, primarily down or up) direction.

The coupler assembly 10 preferably facilitates easy assembly and disassembly of the gooseneck tube mount 18 to the coupler socket housing 14 around the compressible insert 50. For instance, the pivot pin 20 can be held in place using a spiral retaining ring 60. A grease zerk 62 is provided to lubricate the pivot pin 20 and reduce friction during pivoting over the life of the coupler assembly 10.

The coupler socket housing 14 defines a locking pin channel 64 used for locking of the coupler assembly 10 to the tow ball 12. The locking pin channel 64 has a locking pin centerline 66 which extends inwardly to an elevation below the socket hemisphere 22. The locking pin centerline 66 is at an acute locking pin angle β relative to the vertical axis 68 of the tow ball 12 and its neck and/or relative to the vertical axis 52 of the gooseneck tube mount 18 in an unbiased position. The locking pin angle β preferably has a value of no more than 60°, and most preferably has a value of about 30°.

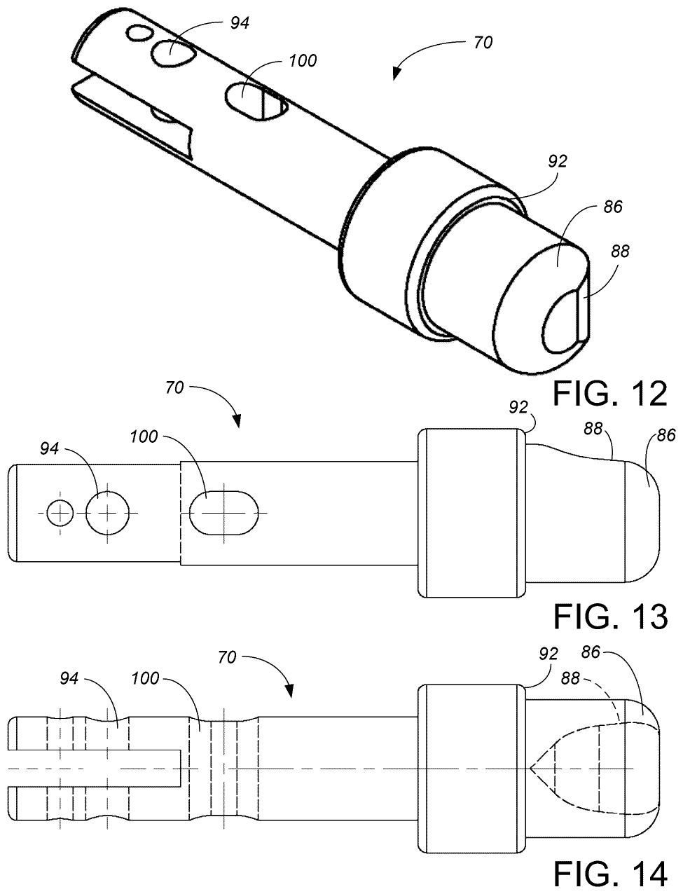

As best shown in FIGS. 3 and 12-22, the lock 16 primarily includes a locking pin 70 which is a clamp or bolt reciprocally movable between a downward locking position which can retain the hitch ball 12 in an engaged, towing position and an upward release position in which the hitch ball 12 can be inserted into the socket hemisphere 22 or removed from the socket hemisphere 22. A compression spring 72 biases the locking pin 70 downwardly toward the locking position. A handle 74 is affixed to the proximal end of the locking pin 70 using a slotted spring pin 76. When the spring-biased pull handle 74 is pulled against the spring pressure, the clamp/bolt 70 is sufficiently pulled from the neck of the hitch ball 12 that the ball 12 can be removed from the coupler assembly 10. The preferred embodiment shown orients the pull handle 74 vertically (i.e., at a 0° orientation) while in the locking position, but an alternative embodiment orients the pull handle 74 differently, such as horizontally, while in the locking position.

The locking pin 70 is held in the locking pin channel 64 during assembly of the coupler 10 using a locking pin housing 78, a cap plate 80 and two cap plate mounting screws 82. The locking pin housing 78 guides the locking pin 70 and handle 74 and also retains the compression spring 72. To better serve both guiding and retaining functions, the preferred locking pin housing 78 encircles the locking pin 70.

The preferred coupler assembly 10 auto-latches. When pulled to the release position, the spring-biased pull handle 74 also allows turning of the locking pin 70 about the locking pin centerline 66. The locking pin housing 78 provides one or more rest shoulders 84, so the locking pin 70 can be turned plus or minus 35° and then held by the rest shoulders 84 at the dis-engaged, release position. The dis-engaged and rotated raised position is considered ready for uncoupling and/or ready for auto-latching. The distal end 86 of the locking pin 70 includes a clearance flat or clearance recess 88. When placed onto or taken off of the hitch ball 12 during a coupling or uncoupling event, the hitch ball 12 pushes against the clearance flat 88 and necessarily rotates the clamp/bolt of the locking pin 70 back to a roughly 0° orientation that enables the clearance recess 88 of locking pin 70 to fit past the hitch ball 12. After the hitch ball 12 slides by, the locking pin 70 (turned back to the 0° orientation) can then move downwardly under the force of the spring 72 to a lowered position which (for coupling) engages against the bottom/neck of the hitch ball 12. The rotational aspect of the locking pin 70 when it slides past the hitch ball 12 together with the angle β of the locking pin 70 means that the user need only operate the pull handle 74 and move the clamp/bolt 70 during uncoupling, with the coupler 10 always being ready for auto-latching engagement with the hitch ball 12 during a next re-coupling event.

The preferred locking pin 70 is machined from 42 Chromium-Molybdenum medium-carbon alloy steel. The locking pin housing 78, the cap plate 80 and the pull handle 74, which do not have to withstand towing forces, are preferably formed out of Q235-B carbon steel.

Manufacturing assembly of the preferred coupler assembly 10 is straight-forward. The locking pin channel 64 in the coupler socket housing 14 is shaped (in particular, a lower shoulder 90 of the inner diameter of the locking pin channel 64, mating with an outer diameter shoulder 92 of the locking pin 70) to only enable assembly by dropping the locking pin 70 downwardly into the locking pin channel 64 of the coupler socket housing 14. The compression spring 72 and the locking pin housing 78 are then positioned around the locking pin 70, and subsequently held in place by the cap plate 80. Once assembled, the cap plate 80 is held to the coupler socket housing 14 by two machine screws 82 so as to fix the locking pin housing 78 to the coupler socket housing 14. After the locking pin 70 is assembled into the coupler socket housing 14, locking pin housing 78 and cap plate 80, the pull handle 74 is fixed to the locking pin 70 by the spring pin 76. All of these parts are easy to manufacture and assemble at low cost. Other embodiments can use other attachment and/or assembly structures and methods, but may be more expensive to produce. For instance, the cap plate 80 and the locking pin housing 78 could be formed as a single part, or the locking pin housing 78 could be integrally formed as part of the coupler socket housing 14. Additionally or alternatively, the pull handle 74 and locking pin 70 could be integrally formed as a single part.

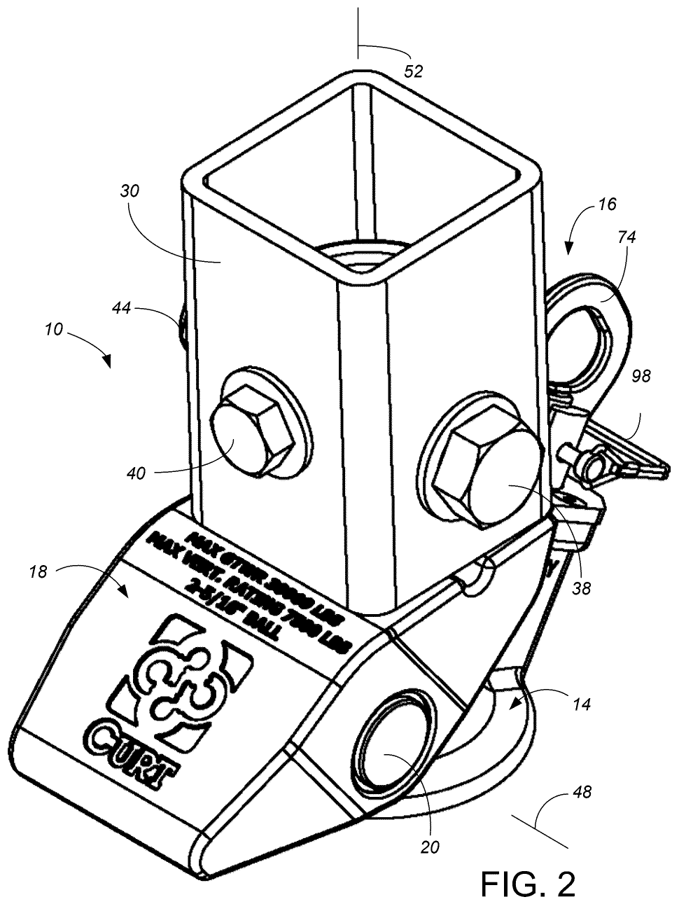

FIG. 2 shows the preferred coupler assembly 10, after it has been mounted on the gooseneck tube 30 of the trailer (not shown), during coupling to the gooseneck hitch ball 12 in the bed of the pickup truck (not shown). As the coupler assembly 10 is lowered onto the gooseneck hitch ball 12, the gooseneck hitch ball 12 contacts the bottom of the locking pin 70, pushing the locking pin 70 upwardly relative to the coupler socket housing 14 and compressing the compression spring 72. Once the gooseneck hitch ball 12 has moved past the locking pin 70, the downward force of the compression spring 72 causes the locking pin 70 to automatically snap downwardly into a coupled position (best shown in the FIGS. 15 and 16). The preferred 30° angle β of the locking pin axis 66 relative to vertical is such that, when the locking pin 70 snaps downwardly into position, the distal end 86 of the locking pin 70 extends inwardly at least past the socket hemisphere 22 and more preferably partially under the gooseneck hitch ball 12 adjacent the neck of the gooseneck hitch ball 12. In the lowered, coupled position, the distal (lower) end 86 of the locking pin 70 will not allow the ball 12 to be removed from the coupler assembly 10. Other angles and shapes of the distal end 86 of the locking pin 70 could alternatively be used, but the 30° angle β has been found to work well both to provide appropriate securement of the coupler assembly 10 to the hitch ball 12 and to simultaneously allow the auto-latching engagement.

In the lowered, coupled position, through holes 94 in the pull handle/locking pin 74/70 align with through holes 96 in the locking pin housing 78. The user then inserts the safety pin 98 through the aligned holes 94, 96 to fix the pull handle/locking pin 74/70 relative to the locking pin housing/coupler socket 78/14, holding the locking pin 70 in the coupled position and preventing the coupler assembly 10 from being pulled off the gooseneck hitch ball 12 during towing.

FIGS. 15-22 show cross-sectional views of the preferred coupler assembly 10, after it has been mounted on the gooseneck of the trailer, during un-coupling from the gooseneck hitch ball 12. As a first step, the user first removes the safety pin 98 from the locking holes 94, 96 of the pull handle/locking pin 74/70 and of the locking pin housing 78. As a second step, the user then pulls the pull handle 74 upwardly, at least ⅝″ in the preferred embodiment, so the bottom of the pull handle 74 is above the rest shoulder 84 of the locking pin housing 78, which also pulls the distal end 86 of the locking pin 70 upwardly out of the neck area (vertical shadow, at least when viewed slightly from the front given the hemisphere cant angle α) of the gooseneck hitch ball 12. As a third step, while holding the pull handle/locking pin 74/70 upwardly, the user then turns the pull handle/locking pin 74/70 35° in either a clockwise or counterclockwise direction. Once raised and turned, the user can release the pull handle 74, and the pull handle/locking pin 74/70 will rest on the rest shoulder 84 of the locking pin housing 78 in a ready-for-uncoupling position. While the locking pin housing 78 could permit rotation up to angles other than +−35°, including permitting rotation in only one of a clockwise or counterclockwise direction, the +−35° allowance has been found both easily and comfortably achieved by users and to provide a secure resting position (i.e., sufficient shoulder surface area in contact with the handle 74) for the locking pin 70. Alternatively, the “slotted” or elongated hole 100 through the locking pin 70 is at an elevation that the user can secure the locking pin 70 in a raised position using the safety pin 98. The safety pin 98 can thus be used to keep the locking pin 70/pull handle 74 in either the locked or release position. An alternative to using the safety pin 98 is to use a keyed or combination lock (not shown) while in the locking position to prevent possible theft. As a fourth step, the user then jacks the trailer upwardly off the gooseneck hitch ball 12. As the trailer is being raised and the uncoupling is occurring, the gooseneck hitch ball 12 contacts the flat 88 on the distal end 86 of the locking pin 70, causing the pull handle/locking pin 74/70 to rotate back (35° in the preferred embodiment) to a ready-for-coupling position with about a 0° orientation of the locking pin 70. The +−35° rotation angle of the handle/locking pin 74/70 has further been found to work well for the gooseneck hitch ball 12 pushing and rotating the locking pin 70 back toward the 0° orientation. Further jacking the trailer higher and raising the coupler 10 off the gooseneck hitch ball 12 allows the locking pin 70 to lower itself within the coupler socket housing 14 assisted by the compression spring 72 after the gooseneck hitch ball 12 has passed by.

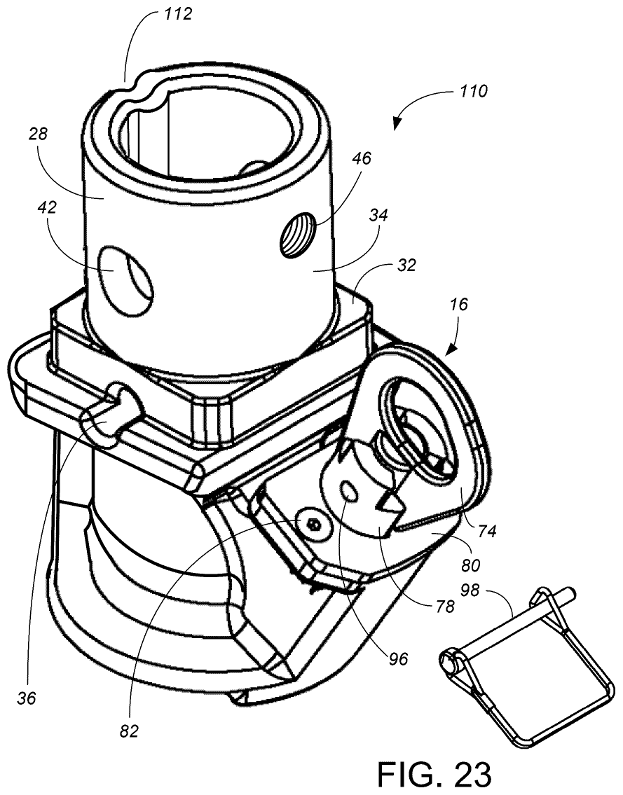

FIG. 23 shows an alternative embodiment 110 that differs in three ways from the primary embodiment. First, the alternative coupler assembly 110 omits the pivot pin 20 and the urethane compressible pad 50, and thus omits the shock damping benefit and concepts of U.S. Pat. Nos. 11,192,408 and 11,685,206. Second, the mounting section 28 includes a weld seam relief 112 extending vertically, allowing greater clearance for a gooseneck tube that has a vertical weld seam (not shown). Third, accounting for the weld seam relief 112, the threaded hole 46 is moved to the rear side rather than the front side of the mounting section 28. The coupler assembly 110 still incorporates the auto-latching lock 16 of the present invention.

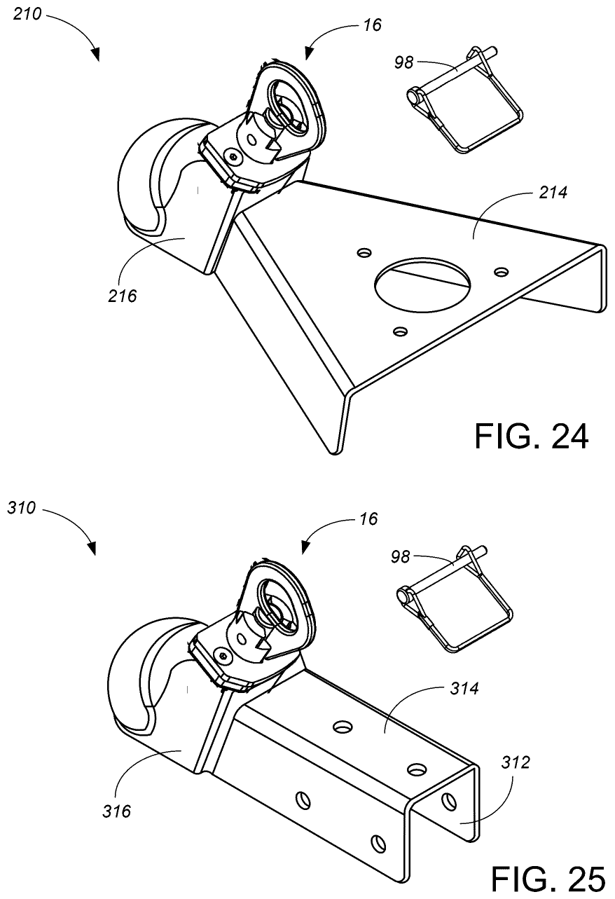

FIG. 24 depicts an alternative embodiment 210 used not for a gooseneck trailer, but instead as a coupler on an A-frame trailer, for coupling to a hitch ball such as on a rear bumper or rear receiver tube (ball mount) of the towing vehicle. FIG. 25 depicts an alternative embodiment 310 used not for a gooseneck trailer, but instead as a coupler on a channel mount trailer, with the depicted version having a 2″ (51 mm) channel 312. Both involve a steel mounting plate 214, 314 that is welded to a socket casting 216, 316, with the socket casting 216, 316 incorporating the auto-latching lock 16 of the present invention.

Although the present invention has been described with reference to preferred embodiments, workers skilled in the art will recognize that changes may be made in form and detail without departing from the spirit and scope of the invention. In particular, all of the dimensions and materials, unless included in the claims, are exemplary only.

What is claimed is:

1. A coupler assembly for use with a gooseneck tow ball or other tow ball, the tow ball defining a generally spherical outer profile extending above a neck, with the generally spherical outer profile defining a tow ball centerpoint, the coupler assembly comprising:
a coupler socket housing, the coupler socket housing defining a socket hemisphere for receiving the tow ball when placed onto the tow ball from above, the coupler socket housing also defining a locking pin channel, the locking pin channel having a locking pin centerline which extends inwardly to an elevation below the socket hemisphere;
a locking pin received in the locking pin channel, the locking pin having a distal end, the locking pin being able to move between a) a locking position wherein the distal end is under the socket hemisphere so as to prevent removal of the coupler assembly from the tow ball; and b) a release position wherein the distal end is positioned wider than the socket hemisphere so as to allow the coupler assembly to be downwardly placed onto the tow ball or upwardly removed from the tow ball; and
a handle, accessible outside the coupler socket housing, which can be used to move the locking pin along the locking pin centerline, and which can also be used to turn the locking pin about the locking pin centerline.

2. The coupler assembly of claim 1, wherein the locking pin is biased toward the locking position with a spring, and wherein the locking pin in the release position can be turned about the locking pin centerline to an orientation where the locking pin is biased by the spring against a rest shoulder that prevents the locking pin from advancing under a spring force back to the locking position.

3. The coupler assembly of claim 2, wherein the rest shoulder is provided by a locking pin housing that encircles the locking pin.

4. The coupler assembly of claim 2, wherein, from the orientation where the locking pin is biased against the rest shoulder, movement of the tow ball past the locking pin causes the tow ball to turn the locking pin about the locking pin centerline and thereafter enable the locking pin to spring back to the locking position.

5. The coupler assembly of claim 1, wherein the locking pin defines at least one safety pin throughhole, and further comprising a safety pin which can be inserted through the safety pin throughhole to prevent the locking pin from movement along the locking pin centerline.

6. The coupler assembly of claim 5, wherein the locking pin defines first and second safety pin throughholes, the first safety pin throughhole enabling the safety pin to hold the locking pin in the locking position, the second safety pin throughhole enabling the safety pin to hold the locking pin in the release position.

7. The coupler assembly of claim 1, further comprising a gooseneck tube mount secured to the coupler socket housing.

8. The coupler assembly of claim 7, wherein the gooseneck tube mount is pivotally secured to the coupler socket housing.

9. The coupler assembly of claim 8, further comprising an elastomeric insert which is compressed by pivoting of the gooseneck tube mount relative to the coupler socket housing.

10. The coupler assembly of claim 8, wherein the gooseneck tube mount defines a gooseneck tube axis, and the pivotally securing of the gooseneck tube mount to the coupler socket housing includes a position where the gooseneck tube axis is substantially collinear with the tow ball centerpoint.

11. The coupler assembly of claim 8, wherein a pivot axis of the gooseneck tube mount relative to the coupler socket housing is offset from the tow ball axis in a direction opposite the locking pin channel.

12. The coupler assembly of claim 7, wherein the gooseneck tube mount is integrally formed with the coupler socket housing as a casting.

13. The coupler assembly of claim 7, further comprising a water drip channel allowing drainage from an interior of the gooseneck tube mount to an exterior of the gooseneck tube mount.

14. A coupler assembly for use with a gooseneck tow ball or other tow ball, the tow ball defining a generally spherical outer profile extending above a neck, with the relationship between the generally spherical outer profile and the neck defining a generally vertical tow ball axis, the coupler assembly comprising:
a coupler socket housing, the coupler socket housing defining a socket hemisphere for receiving the tow ball when placed onto the tow ball from above;
a lock for securing the coupler socket housing to the tow ball when the tow ball is within the socket hemisphere;
a gooseneck tube mount a pivotally secured to the coupler socket housing; and
an elastomeric insert which is compressed by pivoting of the gooseneck tube mount relative to the coupler socket housing.

15. The coupler assembly of claim 14, wherein the gooseneck tube mount defines a gooseneck tube axis, and the pivotally securing of the gooseneck tube mount to the coupler socket housing includes a position where the gooseneck tube axis is collinear with the tow ball axis.

16. The coupler assembly of claim 14, wherein the coupler socket housing defines a locking pin channel, wherein the lock comprises a locking pin received in the locking pin channel, and wherein a pivot axis of the gooseneck tube mount is offset from the tow ball axis in a direction opposite the locking pin channel.

17. The coupler assembly of claim 14, further comprising a water drip channel allowing drainage from an interior of the gooseneck tube mount to an exterior of the gooseneck tube mount.

18. A method of coupling and/or uncoupling to a gooseneck or other hitch ball which allows auto-recoupling, the tow ball defining a generally spherical outer profile extending above a neck, with the relationship between the generally spherical outer profile and the neck defining a generally vertical tow ball axis, the method comprising:
providing a coupler assembly comprising:
a coupler socket housing, the coupler socket housing defining a socket hemisphere for receiving the tow ball when placed onto the tow ball from above, the coupler socket housing also defining a locking pin channel, the locking pin channel having a locking pin centerline which extends inwardly to an elevation below the socket hemisphere;
a locking pin received in the locking pin channel, the locking pin having a distal end, the locking pin being able to move between a) a locking position wherein the distal end is under the socket hemisphere so as to prevent removal of the coupler assembly from the tow ball; and b) a release position wherein the distal end is positioned wider than the socket hemisphere so as to allow the coupler assembly to be downwardly placed onto the tow ball or upwardly removed from the tow ball; and
a handle, accessible outside the coupler socket housing, which can be used to move the locking pin along the locking pin centerline, and which can also be used to turn the locking pin about the locking pin centerline;
pulling the handle to move the locking pin from the locking position to the release position; and
turning the handle so as to turn the locking pin about the locking pin centerline to an orientation where the locking pin is against a rest shoulder that prevents the locking pin from advancing back to the locking position.

19. The method of claim 18, wherein the locking pin is biased toward the locking position with a spring, and wherein the rest shoulder that prevents the locking pin from advancing under a spring force back to the locking position.

20. The method of claim 19, further comprising:
moving the coupler assembly relative to the tow ball such that the tow ball turns the locking pin about the locking pin centerline, thereafter enabling the locking pin to spring back to the locking position.
